(19) United States
(12) Patent Application Publication
(10) Pub. No.: US 2015/0176198 A1
(43) Pub. Date: Jun. 25, 2015

(54) PARTICLE-INTERCONNECTS ON NON-PLANAR SUBSTRATES

(71) Applicant: Aaron D. Strickland, Freeville, NY (US)

(72) Inventor: Aaron D. Strickland, Freeville, NY (US)

(73) Assignee: iFyber, LLC

(21) Appl. No.: 13/065,150

(22) Filed: Mar. 14, 2011

Related U.S. Application Data
(60) Provisional application No. 61/313,412, filed on Mar. 12, 2010.

(51) Int. Cl. D06M 14/04; H01B 1/02; H01B 1/08; D06M 14/08; D06M 14/00

(52) U.S. Cl. CPC D06M 14/04; D06M 14/08; D06M 14/00; H01B 1/08; H01B 1/02; D10B 2201/02; D06M 2101/06

(57) ABSTRACT

Disclosed in this specification is a composition and method for controlled synthesis of interconnects to crosslink nanoparticles, wherein the said particles conformally coat the surface of non-planar substrates. A method is provided for crosslinking nanoparticles that are conformally coated on fibrous materials, wherein the presence of initiator units on the surface of the particles guide the formation of interconnects. A second method uses preformed interconnects to crosslink nanoparticles that are conformally coated on fibrous materials. The nanoparticles on the coating are crosslinked in order to impart new and/or enhanced properties to the particle-coated non-planar substrates.

### CROSS-REFERENCE TO RELATED APPLICATIONS

This application claims priority to and the benefit of co-pending U.S. provisional patent application Ser. No. 61/313,412, filed Mar. 12, 2010, which application is incorporated herein by reference in its entirety.

### STATEMENT REGARDING FEDERALLY FUNDED RESEARCH OR DEVELOPMENT

The disclosed invention was made with government support under contract no. FA8650-09-M-5906 from the U.S. Air Force Research Laboratory.

### FIELD OF THE INVENTION

This invention relates generally to the controlled synthesis of interconnects to crosslink nanoparticles, wherein the said particles conformally coat the surface of non-planar substrates. More specifically, this invention relates to a method for crosslinking nanoparticles that are conformally coated on fibrous materials, wherein the presence of initiator units on the surface of the particles guide the formation of interconnects. A second method related to this invention uses preformed interconnects to crosslink nanoparticles that are conformally coated on fibrous materials. The nanoparticles on the coating are crosslinked in order to impart new and/or enhanced properties to the particle-coated non-planar substrates.

### BACKGROUND OF THE INVENTION

Engineered composite materials, in which the combined constituents possess significantly different physical or chemical properties than the constituents alone, are of considerable interest for many applications. For example, fibrous materials have been coated with metallic deposits to render them electrically conductive. Unfortunately, current technology requires relatively thick layers of metal deposits to achieve adequate conductivity. Precise control over the composition of the constituent materials and their interactions at the atomic and nanometer scale are essential in order to render a material with uniform and coherent properties. The thickness of the deposited metals make such control difficult.

Broadly, the object of the present invention is to provide composite materials comprised of non-planar surfaces conformally coated with particles, where the particles become chemically interconnected. Specifically, the present invention is related to the controlled synthesis of chemical interconnects having a desired property to crosslink the particles, wherein the particles are conformally coated onto the surface of non-planar fibrous materials. There is a need in the art for such composite materials and related methods for the controlled preparation of particle-polymer composite coatings onto fiber surfaces. Unique properties can arise by interconnecting particles that are conformally arranged on fibrous materials including, but not limited to, electric, piezoelectric, dielectric, magnetic, mechanical, and optical properties.

### SUMMARY OF THE INVENTION

The invention pertains to a composition and method for controlled synthesis of interconnects to crosslink nanoparticles, wherein the said particles conformally coat the surface of non-planar substrates. A method is provided for crosslinking nanoparticles that are conformally coated on fibrous materials, wherein the presence of initiator units on the surface of the particles guide the formation of interconnects. A second method uses preformed interconnects to crosslink nanoparticles that are conformally coated on fibrous materials. The nanoparticles on the coating are crosslinked in order to impart new and/or enhanced properties to the particle-coated non-planar substrates.

### BRIEF DESCRIPTION OF THE DRAWINGS

The present invention is disclosed with reference to the accompanying drawings, wherein:

FIG. 1 depicts two routes for forming particle interconnects;

FIG. 2 depicts another route for forming particle interconnects;

FIG. 3 depicts a route for forming silver nanoparticle coated fiber composites (e.g., cotton/cellulose);

FIG. 4 depicts a scanning electron microscopy image of a silver nanoparticle coated cotton fiber composite;

FIG. 5 depicts a route for forming gold nanoparticle coated fiber composites (e.g., cotton/cellulose);

FIG. 6 depicts a scanning electron microscopy image of a gold nanoparticle coated cotton fiber composite;

FIG. 7 depicts another route for forming particle interconnects;

FIG. 8 depicts scanning electron microscopy images of a ZnO:Al nanoparticle coated cotton fiber composite;

FIG. 9 depicts electron dispersive spectroscopy data obtained from a ZnO:Al nanoparticle coated cotton fiber composite;

FIG. 10 depicts a scanning electron image of an electrically conductive fiber comprised on cotton, ZnO:Al nanoparticles and PEDOT interconnects;

FIG. 11 depicts transmission electron microscopy images of an electrically conductive fiber comprised on cotton, Ag nanoparticles and PEDOT interconnects;

FIG. 12 depicts a transmission electron microscopy image of an electrically conductive fiber comprised on cotton, ZnO:Al nanoparticles and PEDOT;

FIG. 13 depicts Raman spectra of a PEDOT:PSS film and an electrically conductive fiber comprised on cotton, ZnO:Al nanoparticles and PEDOT;

FIG. 14 depicts resistance data obtained from various electrically conductive yarns;

FIG. 15 depicts a plot of current vs. voltage from a two-point probe measurement of two different electrically conductive yarns;

FIG. 16 depicts a plot of current vs. voltage from a two-point probe measurement of four different electrically conductive yarns; and

FIG. 17 depicts the conductivity profiles of cotton yarn samples treated with various coatings.

Corresponding reference characters indicate corresponding parts throughout the several views. The examples set out herein illustrate several embodiments of the invention but should not be construed as limiting the scope of the invention in any manner.

### DETAILED DESCRIPTION OF A PREFERRED EMBODIMENT

The present invention is a composite material and methods for making the same. The composite material comprises a non-planar substrate, wherein the substrate includes a conformal coating of nanoparticles and particle interconnects. The particles, and specifically the surface of the particles, serve as scaffolds for the controlled synthesis of a plurality of particle interconnects. The interconnects are grafted onto the surface of the particles via covalent bonds, non-covalent bonds, ionic bonds, or a combination thereof.

The non-planar substrates can be organic, inorganic, natural or synthetic. The non-planar substrates are curved surfaces, wherein the curved surfaces can be high-surface-area morphologies, such as fibers, tubes, wires, and porous surfaces. The high-surface area morphologies can be part of a matrix, wherein the matrix is comprised of a plurality of fibers, wires, tubes or pores. The high-surface area morphologies can also be part of a planar substrate, wherein the high-surface area morphologies are integrated into or onto a planar substrate by physisorption, chemisorption, or by physical approaches including, but not limited to, lithographic fabrication approaches. Examples of organic substrates include high-surface area morphologies having hydrogen bonding donors/acceptors. Examples of organic substrates include, but not limited to, polymers and copolymers comprised of polyamides, polycarboxylic acids (e.g. acrylic acid), polysaccharides (e.g., cellulose, cellulose acetate), polyalcohols (e.g., polyvinylalcohol), polyamines, polyaminoacids (e.g. polylysine), polyvinylpyrrolidone, polyethylene oxide, and specialized fibers of block copolymers having nucleobase functionality (e.g. adenine and thymine). Examples of natural fibers include, but are not limited to, cotton, esparto grass, bagasse, kemp, flax, silk, wool, wood pulp, chemically modified wood pulp, jute, rayon, ethyl cellulose and cellulose acetate. Examples of synthetic fibers include, but are not limited to, polyvinyl chlorides, polyvinyl fluorides, polytetrafluoroethylenes, polyvinylidene chlorides, polyacrylics (e.g. Orlon®), polyvinyl acetate, polyethylvinyl acetate, non-soluble or soluble polyvinyl alcohols, polyolefins such as polyethylene (e.g. Pulpex®) and polypropylene, polyamides such as nylon (e.g. nylon-6; nylon-6,6; nylon-12), polyesters such as Dacron® or Kodel®, polyurethanes, polystyrenes, and the like. The fibers can be naturally occurring fibers, synthetic fibers or a combination thereof. Examples of wires include metal wires, such as copper, iron, gold, platinum, silver, nickel, cobalt and alloys of the aforementioned metals. Examples of semiconductor wires include IV group semiconductors (e.g. Si, Ge), III-V group semiconductors (e.g. GaAs, InAs), II-VI group semiconductors (e.g. CdSe, ZnO), and compounds and alloys of the aforementioned group semiconductors. The tubes can be hollow materials of the aforementioned metallic and semiconductor wire materials. Examples of other porous surfaces include, but not limited to, porous titania, silica, zirconia, and aluminosilicates. The fibers can be part of textiles, wherein the textiles include, but are not limited to, woven textiles, non-woven textiles, woven composites, braids, or yarns. The fibers, tubes, wires, and porous surfaces can have a cross-sectional diameter in the range of 10 nm and 100 μm.

The particles can be metals (e.g. Au, Ag, Cu, Pt, Pd), metal oxides (e.g. ZnO, AgO, TiO₂, SnO₂), semiconductors (e.g. Al-doped ZnO, CdSe, GaAs), magnetic (e.g. Fe, Ni, Co), non-metallic oxide (e.g. SiO₂) or organic (e.g. polystyrene, carbon particles) in nature. The particles can have a cross-sectional diameter in the range of 1-2000 nm. In one embodiment, the particles are from about 10-200 nm. In another embodiment, the particles are from about 50-150 nm. In another embodiment, the particles are about 100 nm in diameter. The average distance between adjacent particles across the entire non-planar surface is no greater than 10 times the largest cross-sectional dimension of any particle in the plurality. For example, if the average particle size was about 100 nm, then the particles are coated on the substrate such that there is no more than 1000 nm between each of the particles.

The particles are deposited such that the resulting layer is less than about 200 nm thick. In another embodiment, the resulting layer is less than about 100 nm thick. In one embodiment, the fiber composite material containing particles and particle interconnects is preferably less than about 10 weight percent particle and preferably a 20 weight percent particle and interconnect combined.

The interconnects can be natural or synthetic materials such as synthetic organic oligomers and polymers, natural oligomers and polymers (e.g. DNA, RNA, proteins), other organic materials (e.g., carbon nanotubes), or inorganic metal complexes. The interconnects can have properties such as hydrophobic, hydrophilic, conducting, semiconducting or non-conducting in nature. Examples of conducting interconnects include conjugated π systems such as polythiophene, polypyrrole, polyaniline, and polyphenylene sulfide. Examples of hydrophobic interconnects include aliphatic polymers (e.g. polyethylene), perfluorinated polymers (e.g., Teflon®), and vinyl polymers such as polystyrene. Examples of hydrophilic interconnects include polyalkylene glycols (polyethylene glycol, polypropylene glycol, and the like) or other polar interconnects.

In one embodiment of the invention, a method is provided that produces a coated non-planar substrate. In the first step of this method, particles are attached to the non-planar substrate. Any suitable method for attaching the particle to the substrate may be used. For example, one may use covalent bonds, electrostatic attraction and/or entanglement. The exact method of attachment will vary depending on the nature of the substrate and the nature of the particle.

In one embodiment, the non-planar substrate is fibrous cotton and the nanoparticle is a metal or metal oxide. Methods for cationically charging the surface of such fibers are known. See WO 2009/129410, the content of which is incorporated by reference into this specification, and Hauser, P. and A. Tabba, Improving the environmental and economic aspects of cotton dyeing using cationised cotton. Coloration Technol., 2001. 117: p. 282-288. Once the substrate is positively charged, negatively charged nanoparticles can be deposited. Conversely, anionic charged substrates can be used to deposit cationic nanoparticles. For example, aqueous gold or silver nanoparticle suspensions can be prepared using standard procedures by the reduction of gold or silver metal salts using sodium citrate. The resulting negatively charged, citrate stabilized gold or silver nanoparticles can then be attached to cationic cotton by electrostatic attraction.

Once the particles are attached to the substrate, interconnects are formed between the particles. Two methods for forming interconnects are disclosed. First, initiator units are formed on the nanoparticles and the interconnects are grown in situ between the initiator units. Second, preformed interconnects are exposed to the nanoparticles and subsequently bind thereto.

### In Situ Interconnects

In one aspect of the previous embodiment, attachment of the initiator units to the particle surface requires compatible chemistry in both parts. Examples include, but are not limited to, initiator units having thiol functional groups for binding Au, Ag, Cu, or Pd particles. Another example includes initiator units having carboxyl functional groups for binding metal oxide particles such as ZnO, Fe₂O₃, or TiO₂. Yet another example includes initiator units having silane functional groups for binding particles comprised of SiO₂, ZnO, or TiO₂. One example of covalent attachment of the initiator units to the particle surface would be to use standard amine-carboxyl coupling chemistry, whereby carboxylic acids are activated and coupled with an amine to form an amide linkage. In yet another example, initiator units having formal charge (e.g., metal ion catalysts) can also be bound (i.e. localized) to the nanoparticle surface by electrostatic bonding. A skilled artisan would understand that the only requirement in the bonding between initiator units and the particle surface is that the chemistry is complementary, and the present invention is not limited to particular examples of complementary chemistry set forth herein.

In one embodiment, a method is set forth for synthesizing particle interconnects in situ on the particle-coated non-planar surfaces. The non-planar substrates coated with particles are modified to provide initiator units on the surface of the particles. The initiator units may be monomers, catalysts, or polymerization initiators. Individual chemical building blocks interact with the initiator units on the particles and polymerize into linear or branched interconnects to crosslink the particles. The polymeric interconnects can crosslink the particles via covalent, non-covalent and/or ionic bonds. Liquid-phase or gas-phase approaches can be employed in the growth of the polymeric interconnects. The polymeric interconnects may exhibit a plurality of properties that include, but are not limited to hydrophobicity, hydrophilicity, electrical conductivity, thermal conductivity, semiconducting, or insulating properties.

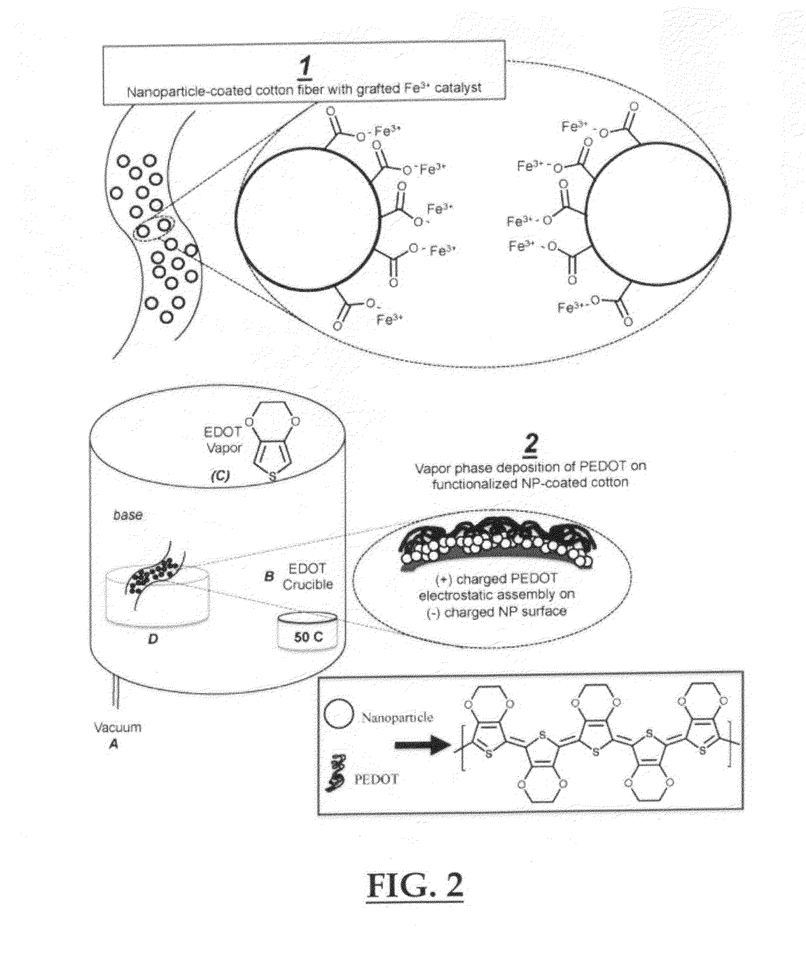

By way of illustration, in one embodiment of the invention, highly conductive cotton fibers are fabricated using layer-by-layer self-assembly of metal or metal oxide nanoparticles (e.g., Au, Ag, ZnO, Al-doped ZnO) onto cotton substrates (refer to FIG. 2). The nanoparticle-coated fibers are further functionalized with a polymerization catalyst (e.g., Fe³⁺) and base (e.g., pyridine). Addition of 3,4-ethylenedioxythiophene under reduced pressure and elevated temperature results in oxidative vapor-phase polymerization of poly(3,4-ethylenedioxythiophene) onto the surface of the nanoparticle-coated fibers. The resulting composite material exhibits improved conductivities when compared to PEDOT-coated cotton not previously coated with nanoparticles.

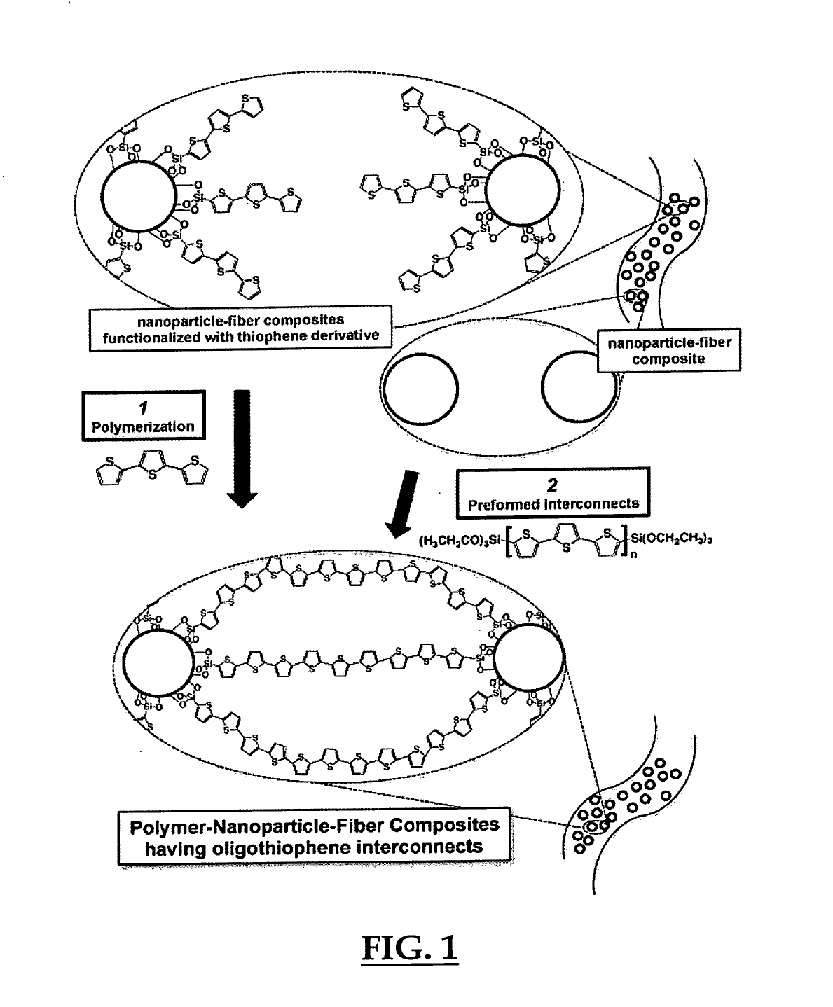

By way of further illustration, in another embodiment of the invention, the metal or metal oxide nanoparticles (e.g., Ag, Au, ZnO, Al-doped ZnO) coated onto the fibrous substrates can be functionalized with a modified thiophene derivatives, a modified 3,4-ethylenedioxythiophene derivatives, or similar compounds (refer to FIG. 1, ‘polymerization’ scheme). These a modified derivatives contain reactive groups at their a terminus that allow nanoparticle surface binding and are compounds that can be polymerized at their a) terminus. As an example of this method, thiophenes or 3,4-ethylenedioxythiophenes having triethoxysilane a functionality can be used to functionalize the surface of ZnO particles, thereby giving polymer initiator units on the surface of the particle. As another example of this method, thiophenes or 3,4-ethylenedioxythiophenes having either thiol or phosphine a functionality can be used to functionalize the surface of Ag or Au particles, thereby giving polymer initiator units on the surface of the particle. Addition of thiophenes, 3,4-ethylenedioxythiophenes, or similar polymer subunits under a plurality of polymerization conditions will furnish a network of polymer interconnected ZnO, Al-doped ZnO, Ag, or Au particles on the surface of fibrous materials.

### Preformed Interconnects

In one aspect of the previous embodiment, attachment of the preformed interconnects to the particle surface requires compatible chemistry in both parts. Examples include, but are not limited to, preformed interconnects having thiol functional groups for binding Au, Ag, Cu, or Pd particles. Another example includes preformed interconnects having carboxyl functional groups for binding metal oxide particles such as ZnO, Fe₂O₃, or TiO₂. Yet another example includes preformed interconnects having silane functional groups for binding particles comprised of SiO₂, ZnO, or TiO₂. One example of covalent attachment of the preformed interconnects to the particle surface would be to use standard amine-carboxyl coupling chemistry, whereby carboxylic acids are activated and coupled with an amine to form an amide linkage. In yet another example, preformed interconnects having formal charge (e.g., either anionic or cationic) can also be bound to the nanoparticle surface by electrostatic bonding. A skilled artisan would understand that the only requirement in the bonding between preformed interconnects and the particle surface is that the chemistry is complementary, and the present invention is not limited to particular examples of complementary chemistry set forth herein.

In another embodiment of the invention, the particle-coated non-planar substrates are treated with preformed interconnects using solvents or in the gas phase (refer to FIG. 1, ‘preformed interconnects’ scheme). The preformed interconnects possess α and ω functionalities that crosslink the particles via covalent, non-covalent and/or ionic bonds. The preformed interconnects can be bidentate or polydentate ligands comprised of natural (e.g. protein, DNA, RNA), or synthetic (e.g. alkanethiolates, alkylsilanes, polymers, carbon nanotubes) materials. By way of illustration, α,ω alkoxy silane modified interconnects can be used to connect two or more metal oxides. Further examples include α,ω mercaptan modified interconnects used to connect two or more gold particles. Although the aforementioned α,ω modified interconnects are bidentate, it should be understood that polydentate interconnects may also be used. The length of the interconnect is designed to correspond to the distance between the nanoparticles. For example, if the average particle size was about 100 nm, then the particles are coated on the substrate such that there is no more than 1000 nm between each of the particles. In such an embodiment, the length of the interconnect is designed to be no more than 1000 nm long.

In one aspect of the present invention, the particle interconnects can impart enhanced electrical properties and thermal conductive properties to the fiber materials coated with metal and n-doped semiconductor particles. Potential uses of the technology set forth herein include, but are not limited to, antistatic materials, heating and/or cooling devices, electromagnetic shielding devices, sonochemical devices, medical devices, artificial tissues (e.g., tendons, muscle, neurons), piezoresistive materials, security paper technology, tamper resistant products, and electronic textile components.

In another aspect, the particle interconnects produced in accordance with the present invention can impart multifunctional properties such as antibacterial and conductive properties to fiber materials coated with biocidal particles (e.g. Ag, Cu, CuO).

A skilled artisan would understand that the present invention is not limited to particular variations set forth herein. Various changes may be made to the invention described and equivalents may be substituted without departing from the description and scope of the invention.

In one embodiment, there are set forth applications in PCT Patent Application No. PCT/US09/40853 entitled “Conformal Particle Coatings on Fibrous Materials”. Also see U.S. Publication 2009/0094954 entitled “Autifouling composite material. The content of the aforementioned publications is incorporated by reference into this specification. Other applications include RFID tagged smart materials, stress sensors, flexible transistors, photovoltaic devices, garment point of failure devices, faraday cage devices, anti-counterfeit devices, radiation obscurants (e.g, near-infrared and infrared radiation, radar, gamma radiation), applications involving plasmon enhancement and/or control.

Details of and variations of the described method and related methods, materials, and compositions are set forth in the appendices: (A) “Transparent Polymeric-Zinc Oxide Coatings for Highly Conductive Cotton” and (B) “Nanostructured Smart Yarns for Sensing Garment Point-of-Failure” found in U.S. Ser. No. 61/313,412, filed Mar. 12, 2010, which application is incorporated herein by reference in its entirety.

Referring to FIG. 1, distinct routes for forming particle interconnects are shown; 1) polymerization of a thiophene derivative after functionalizing a particle surface with thiophene initiator units, and 2) formation of particle interconnects using preformed interconnects.

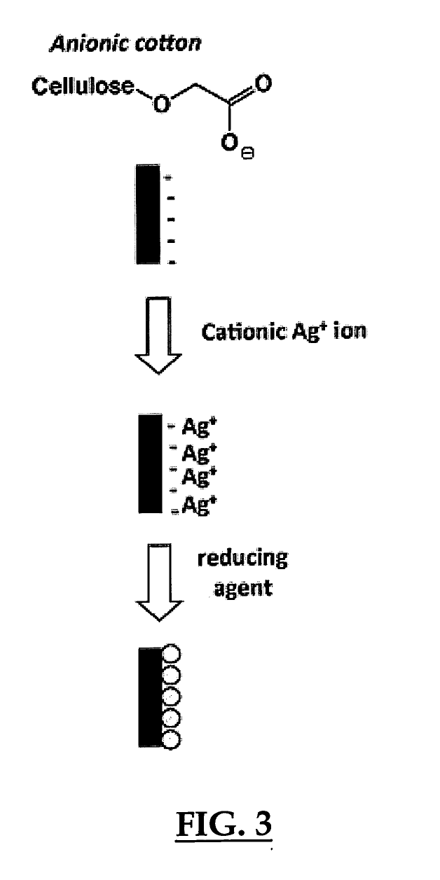

FIG. 2 depicts another distinct route for forming particle interconnects by grafting polymerization catalysts (e.g., Fe³⁺) onto the particle surface. Nanoparticle-cotton composites (1) are interconnected with PEDOT-based particle interconnects as shown in 2 via vapor phase polymerization. A reaction chamber is evacuated using a roughing pump (A) in order to vaporize EDOT monomer at low temperatures (B-C). PEDOT is deposited onto the nanoparticle-coated cotton substrate via vapor phase polymerization (Fe/base catalyzed oxidation). FIG. 3 depicts a route for forming silver nanoparticle coated fiber composites (e.g., cotton/cellulose).

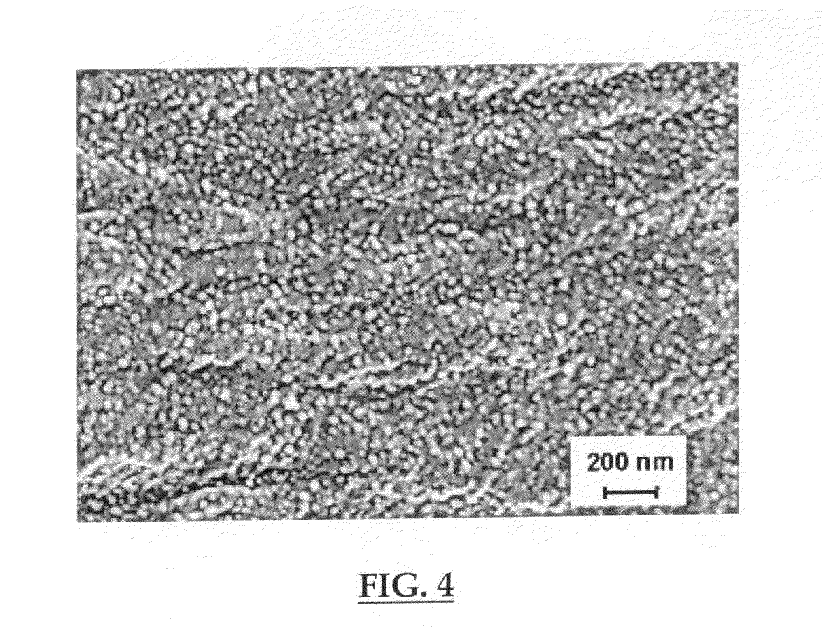

FIG. 4 depicts a scanning electron microscopy image of a silver nanoparticle coated cotton fiber composite.

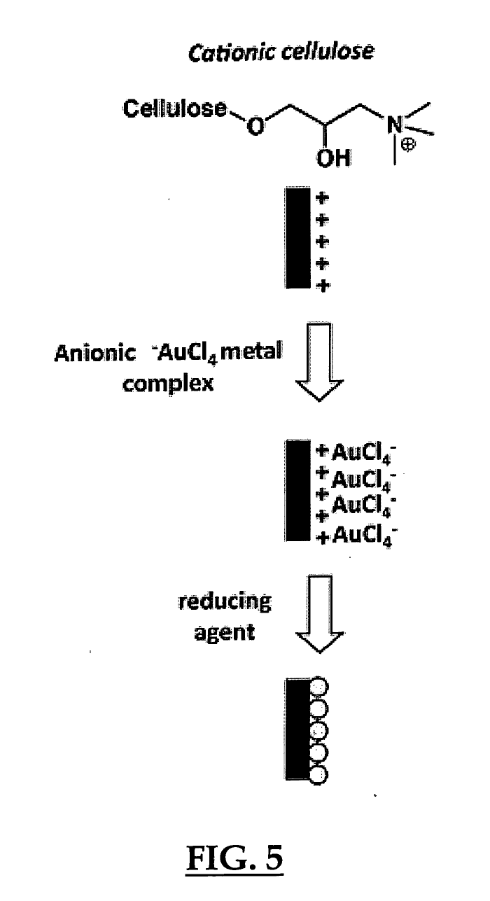

FIG. 5 depicts a route for forming gold nanoparticle coated fiber composites (e.g., cotton/cellulose).

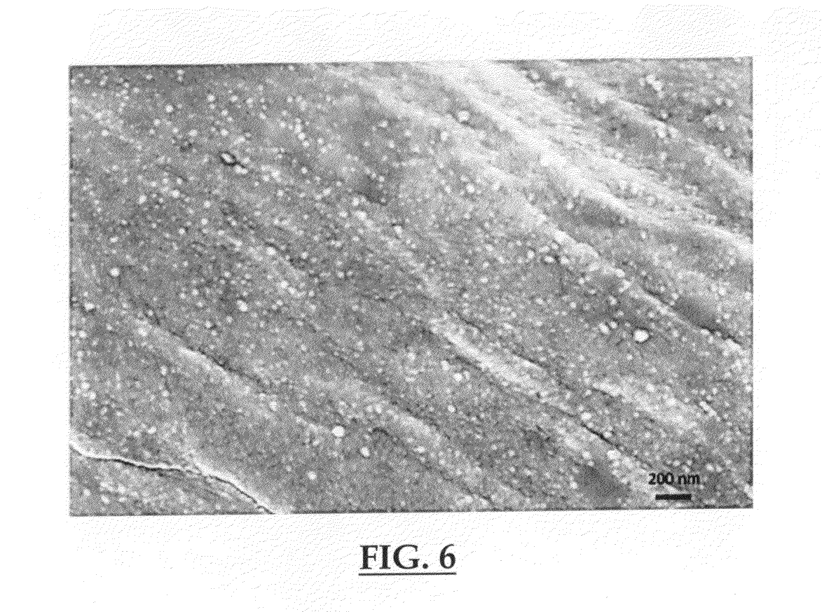

FIG. 6 depicts a scanning electron microscopy image of a gold nanoparticle coated cotton fiber composite.

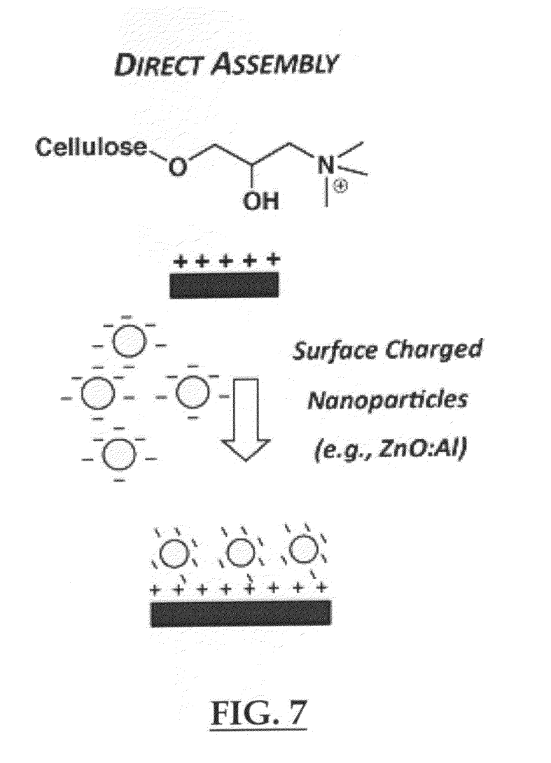

FIG. 7 depicts a route for forming nanoparticle coated fiber composites using preformed negatively charged nanoparticles (e.g., aluminum-doped zinc oxide; ZnO:Al), and positively charged fibers (e.g., cationic cotton/cellulose).

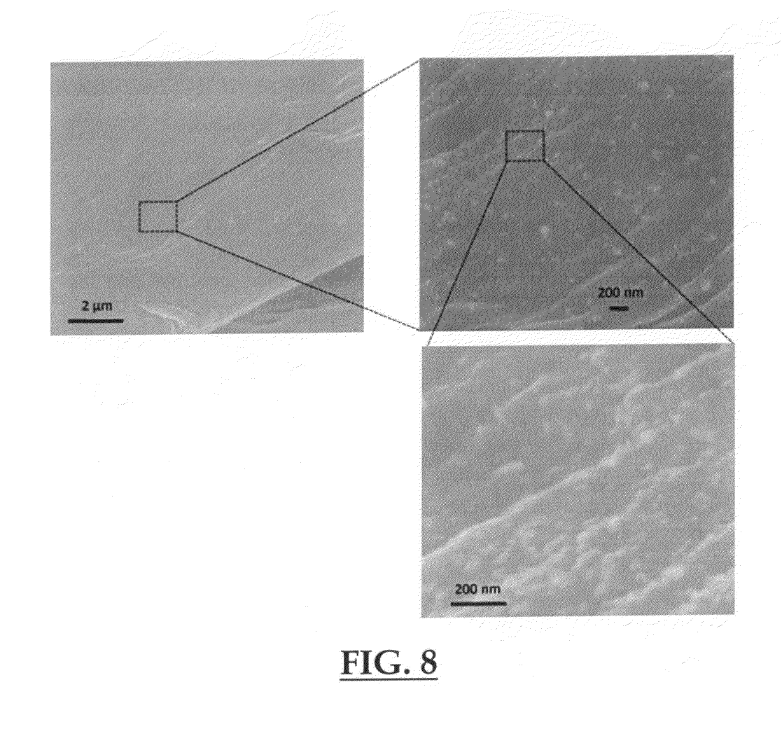

FIG. 8 depicts scanning electron microscopy images of a ZnO:Al nanoparticle coated cotton fiber composite.

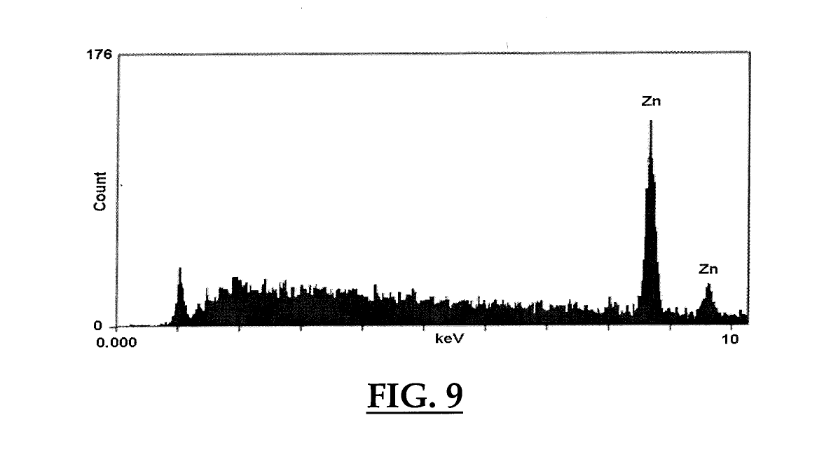

FIG. 9 depicts electron dispersive spectroscopy (EDS) data obtained from a ZnO:Al nanoparticle coated cotton fiber composite.

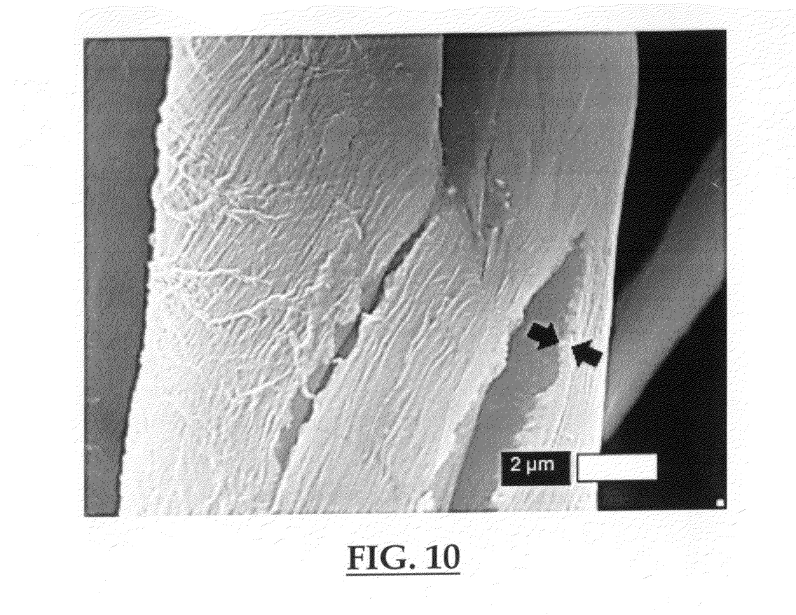

FIG. 10 depicts a scanning electron image of an electrically conductive fiber after PEDOT vapor phase polymerization onto ZnO:Al nanoparticle coated cotton fiber. The arrows indicate the presence of a thin film that is approximately 100 nm thick and is comprised of a ZnO:Al-PEDOT composite material deposited onto the surface of a cotton fiber.

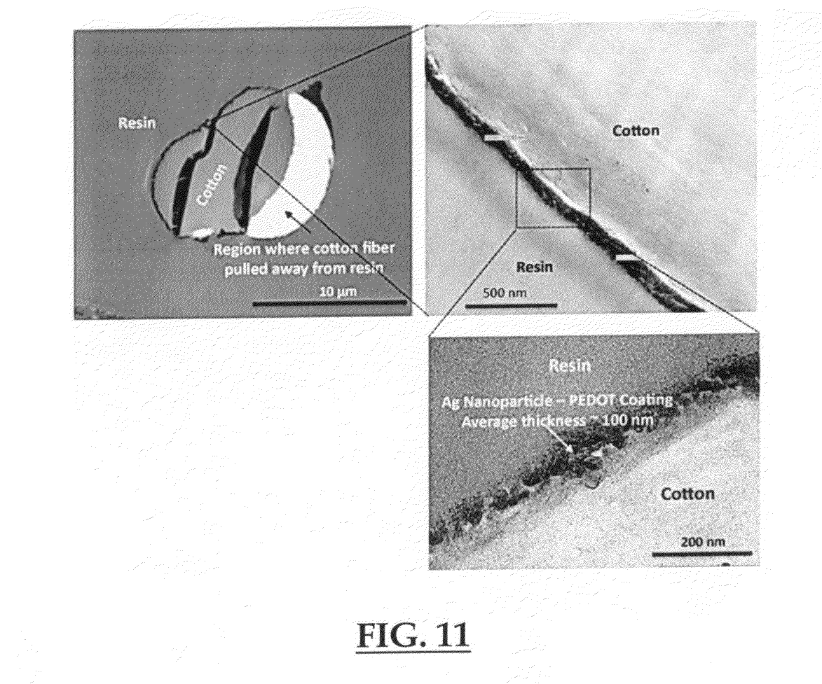

FIG. 11 depicts transmission electron microscopy images of a cross section comprised of an electrically conductive fiber embedded in resin. The electrically conductive fiber was prepared by PEDOT vapor phase polymerization onto a silver nanoparticle coated cotton yarn.

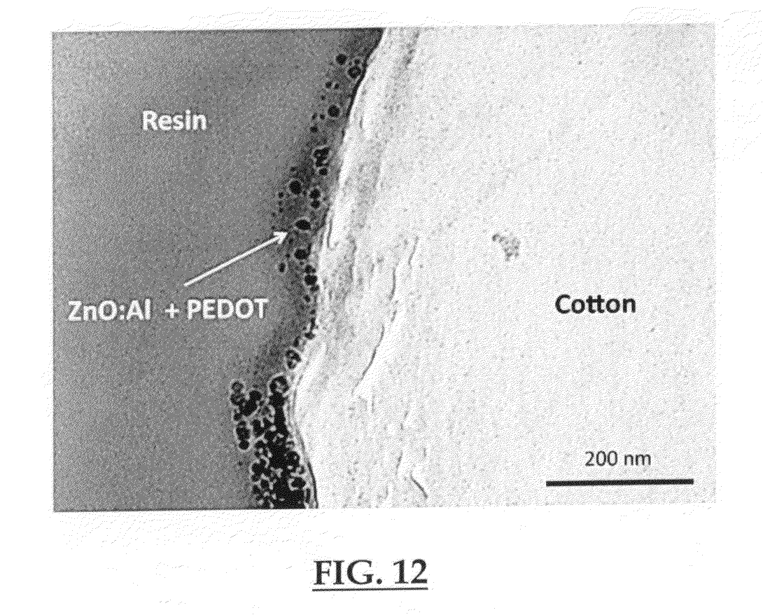

FIG. 12 depicts a transmission electron microscopy image of a cross section comprised of an electrically conductive fiber embedded in resin. The electrically conductive fiber was prepared by PEDOT vapor phase polymerization onto a ZnO:Al nanoparticle coated cotton yarn.

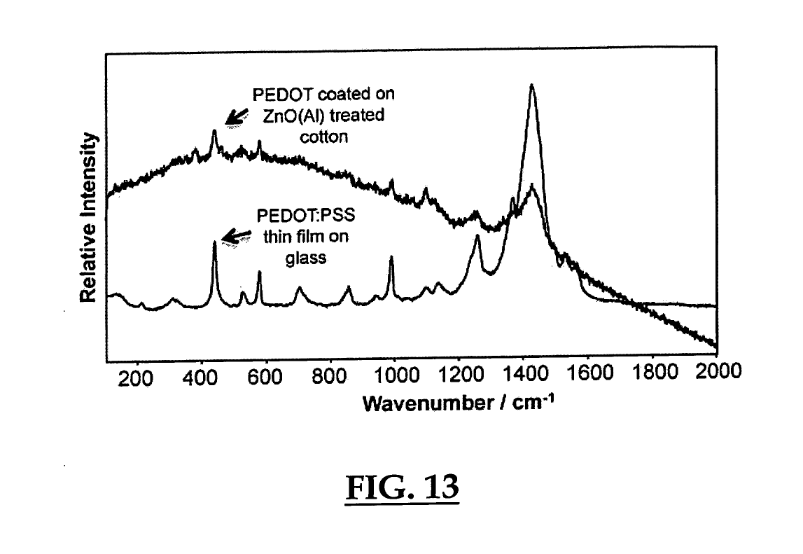

FIG. 13 depicts a Raman spectrum obtained from the surface of a ZnO:Al-PEDOT-cotton conductive fiber (A). For comparison, a Raman spectrum of PEDOT-polystyrene sulfonic acid polymer film is also shown (B).

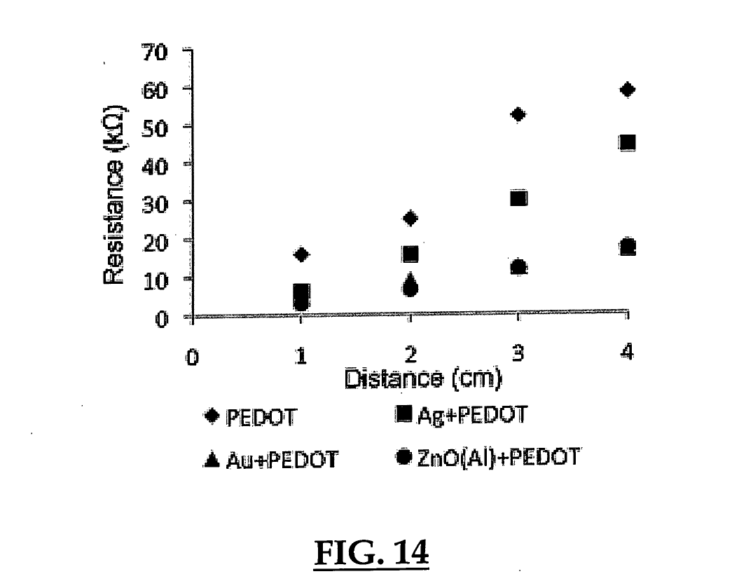

FIG. 14 depicts resistance data obtained from various electrically conductive yarns while applying a constant voltage across the yarns at various distances. ‘PEDOT’ refers to a cotton yarn containing only a PEDOT coating, and Ag+PEDOT, Au+PEDOT, and ZnO(Al)+PEDOT refer to yarns containing a PEDOT coating on the respective nanoparticle coated yarns.

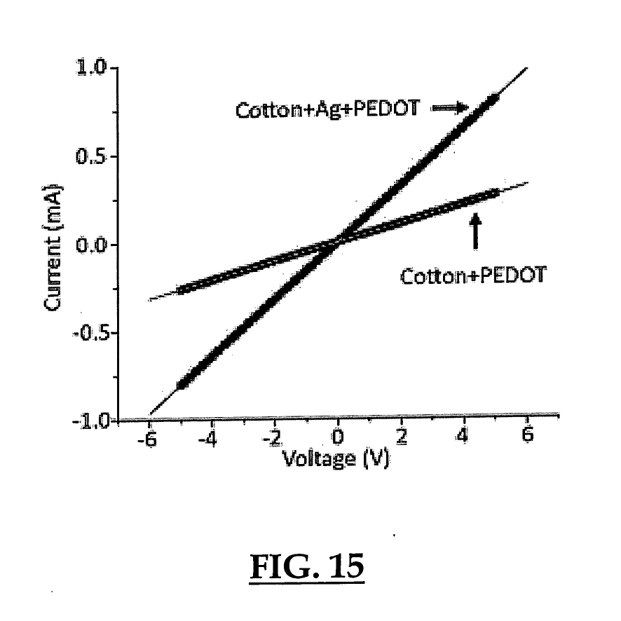

FIG. 15 depicts a plot of current vs. voltage from a two-point probe measurement of two different electrically conductive yarn: silver nanoparticle coated cotton after PEDOT vapor phase polymerization (Cotton+Ag+PEDOT), and plain cotton coated with PEDOT via vapor phase polymerization (Cotton+PEDOT).

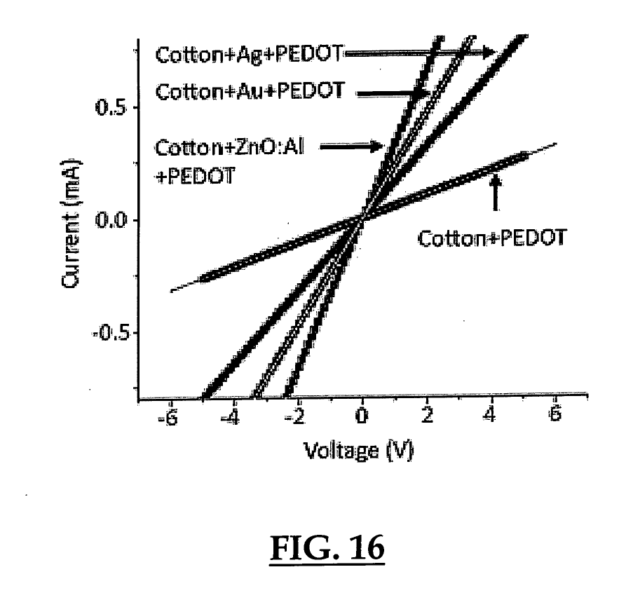

FIG. 16 depicts a plot of current vs. voltage from a two-point probe measurement of four different electrically conductive yarns: silver, gold or ZnO:Al nanoparticle coated cotton yarns after PEDOT vapor phase polymerization, and plain cotton coated with PEDOT via vapor phase polymerization (Cotton+PEDOT).

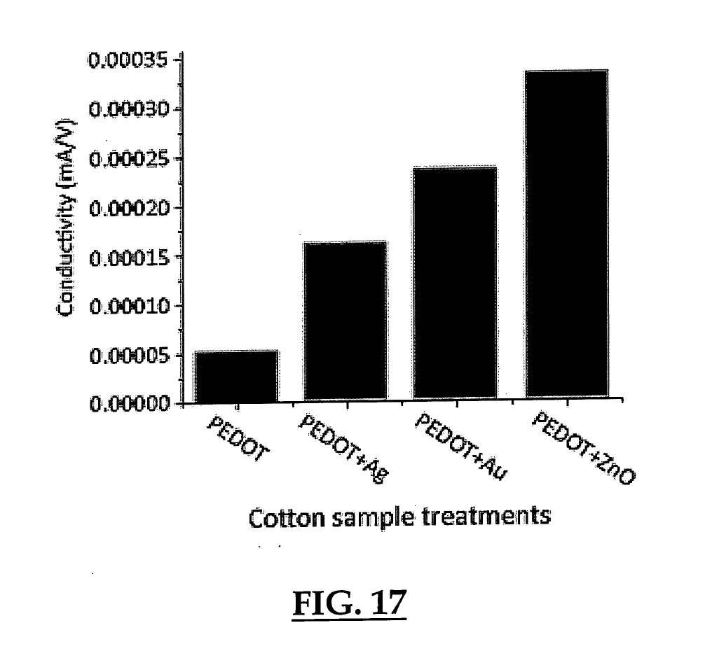

FIG. 17 depicts the conductivity profiles of cotton yarn samples treated with various coatings (i.e., PEDOT vapor phase polymerization, or various nanoparticles followed by PEDOT vapor phase polymerization).

### EXAMPLES

The following example describes a method for depositing silver nanoparticle coatings onto cellulose fibers. Silver coated cotton substrates were prepared starting from carboxymethylated cotton threads (i.e., anionic cotton) as described in WO 2009/129410 A1. Anionic cotton was prepared using a procedure adapted from Hauser et. al. (Product and Method for Treating Cotton, U.S. Pat. No. 7,166,135 B2). Briefly, cotton threads were washed with an aqueous solution of potassium carbonate, followed by a water wash, and the resulting threads were immersed in an aqueous solution of the sodium salt of chloroacetic acid at 60° C. This mixture was incubated for 15 min, and excess reagent was removed by pad application at 100% pickup. The resulting cotton samples were then oven dried at 120° C. for 15 min. Samples were then neutralized with 0.1 M acetic acid and water rinsed until the washings were pH ˜7. Neutralized samples were then immersed into various 1-10 mM AgNO₃ solutions and incubated at room temperature for 3 hrs. Excess metal-ion was removed from the cotton substrate by washing at least 3 times with RO water, and the cotton-Ag⁺ chelate was reduced to silver nanoparticles by introducing an aqueous solution of sodium borohydride (50 mM). A schematic showing this nanoparticle deposition process is provided in FIG. 3. The resulting nanoparticle coated cotton samples were washed thoroughly with RO water, dried at room temperature, and characterized by scanning electron microscopy (FIG. 4).

The following example describes a method for depositing gold nanoparticle coatings onto cellulose fibers. Gold coated cotton substrates were prepared starting from cotton substrates that were modified to render the surface cationic (i.e., cationic cotton) following procedures adapted from Hauser, P. and A. Tabba, Improving the environmental and economic aspects of cotton dyeing using cationised cotton. Coloration Technol., 2001. 117: p. 282-288. Gold nanoparticles were then applied following procedures adapted from Dong, D. and J. P. Hinestroza, Metal Nanoparticles on Natural Cellulose Fibers: Electrostatic Assembly and In Situ Synthesis. ACS Appl. Mater. Interfaces, 2009. 1(3): p. 797-803. Briefly, cotton threads were washed with an aqueous solution of sodium carbonate (2 g/L) for 30 min at 50° C., followed by a water wash. A solution of (3-chloro-2-hydroxypropyl)trimethylammonium chloride (0.33M to 3M) was heated at 60° C. with subsequent addition of a (0.73M to 6.6. M) NaOH solution and stirred for 2 min. The cotton substrates were immersed in the solution at 60° C. for 15 min. The resulting cotton samples were then oven dried at 110° C. for 30 min. Samples were then neutralized with 0.1 M acetic acid and water until the washings were pH ˜7. Neutralized samples were then immersed into NaAuCl₄ solutions (1-10 mM) and incubated at room temperature for 3 hrs. Excess NaAuCl₄ was removed from the cotton substrate by washing at least 3 times with RO water, and the cationic cotton-AuCl₄⁻ complex was reduced to gold nanoparticles by introducing an aqueous solution of sodium borohydride (50 mM). A schematic showing this nanoparticle deposition process is provided in FIG. 5. The resulting nanoparticle coated cotton samples were washed thoroughly with RO water, dried at room temperature, and characterized by scanning electron microscopy (FIG. 6).

The following example describes a method for depositing aluminum-doped zinc oxide nanoparticles coatings on cellulose fibers. Aluminum-doped zinc oxide (ZnO:Al) cotton substrates were prepared starting from aqueous dispersions of negatively charged ZnO:Al nanoparticles, and cationic cotton substrates prepared as described in Example 2. Negatively charged ZnO:Al nanoparticles were then applied following procedures adapted from Dong D. and J. P. Hinestroza, Metal Nanoparticles on Natural Cellulose Fibers: Electrostatic Assembly and In Situ Synthesis. ACS Appl. Mater. Interfaces, 2009. 1(3): p. 797-803. Briefly, negatively charged ZnO:Al nanoparticle solutions at a concentration of 0.1% by weight were incubated with cationic cotton yarns at room temperature for at least 10 min. Excess ZnO:Al material was then removed by washing the substrates with RO water at least three times at room temperature. The composite material was then oven dried at a temperature of at least 50 degrees centigrade for at least 10 min. FIG. 7 shows a schematic drawing of the direct deposition process, FIG. 8 shows scanning electron microscopy data and FIG. 9 shows electron dispersive spectroscopy (EDS) data for the resulting materials.

The following example describes the synthesis of particle interconnects via vapor phase polymerization reaction on nanoparticle coated cellulose fibers. The nanoparticle-coated cotton substrates were dipped in a solution of 125:25:1 wt % of isopropanol:Fe(III)-tosylate:pyridine. The iron complex was either physisorbed on the surface of the silver or gold nanoparticle-coated fibers or chelated by the presence of carboxylic acids groups on the surface of the nanoparticles. For example, mercaptopropionic acid can be incubated with gold and silver coated fibers to provide carboxylate groups on the surface of the particles. The ion catalyzed the vapor phase polymerization reaction of 3,4-ethylenedioxythiophene monomers on the surface and between the particles on the fibers. In the vacuum chamber the nanoparticle-coated cotton threads were kept at 35° C. and a crucible containing ˜100 μL EDOT was heated up to 80° C. Pressure during polymerization was around 100 Torr. The polymerization time was approximately of 30 minutes. FIG. 2 illustrates this process of forming particle interconnects via vapor phase polymerization. Scanning electron microscopy and/or transmission electron microscopy of the resulting polymer interconnect-nanoparticle-fiber material confirmed the presence of a nanoparticle-PEDOT composite matrix. FIGS. 10-13 show representative SEM, TEM, and Raman analysis, which confirms the presence of a PEDOT coating.

The following example describes the electrical characterization of various nanoparticle coated cotton fibrous yarns bearing PEDOT particle interconnects. The electrical conductivity of the individual NP-polymer-cotton composite yarns were measured using a standard two-point-probe method. A basic strategy to measure the electrical characteristics of the composite yarns is to measure the electrical resistance, which is defined as R≡ΔV/ΔI. Thus, given a wire of length (L), a voltage (ΔV) is applied at its ends and the current (ΔI) is measured. Current intensity (i.e., ΔI) was measured using an ammeter while supplying a voltage. A simple two-point probe measurement was used in order to minimize problems associated with improper contact between the yarn and the probes. Table 1 summarizes the data we obtained for all of the yarn types.

TABLE 1
Electrical properties of cotton and cotton composites.

| | Resistance (R) | Current (I) | |
|---|---|---|---|
| Sample | (V = +5 V) | (V = +5 V)* | |
| Cotton | GΩ | nA | |
| Cotton + Ag° or Au° | GΩ | nA | |
| Cotton + PEDOT | 4 cm = 58 kΩ | ~100 | μA |
| | 3 cm = 52 kΩ | | |
| | 2 cm = 25 kΩ | | |
| | 1 cm = 16 kΩ | | |
| Cotton + Ag° + PEDOT | 4 cm = 44 kΩ | ~1 | mA |
| | 3 cm = 30 kΩ | | |
| | 2 cm = 16 kΩ | | |
| | 1 cm = 6 kΩ | | |
| Cotton + Au° + PEDOT | 4 cm = 17 kΩ | >1 | mA |
| | 3 cm = 12 kΩ | | |
| | 2 cm = 9 kΩ | | |
| | 1 cm = 4 kΩ | | |
| Cotton + ZnO(Al) + PEDOT | 4 cm = 17 kΩ | >1 | mA |
| | 3 cm = 12 kΩ | | |
| | 2 cm = 7 kΩ | | |

1 cm = 3 kΩ

*measured at 1 cm

Table 1 lists representative data regarding the electrical properties of various cotton and cotton composites. The cotton composites referred to in this figure include: cotton with a coating of either silver or gold nanoparticles (e.g., Cotton+Ag^{o} or Au^{o}, cotton with a coating of PEDOT (e.g., Cotton+PEDOT), and cotton with a coating of various nanoparticles and PEDOT (e.g., Cotton+Ag^{o}+PEDOT, Cotton+ZnO(Al), and Cotton+Au^{o}+PEDOT). Measurements of resistance or amperage were made using a two probe measurement at a constant voltage of positive 5 volts.

As shown in Table 1, cotton yarns without any coating give very high resistances (giga-ohms; 10⁹Ω) and there is not a linear correlation between measured resistance and the distance between the two probes (i.e., V≠IR). Similarly, cotton yarns coated with aluminum-doped zinc oxide (ZnO:Al), silver and gold nanoparticles only (i.e., prior to PEDOT deposition) as described in examples 1, 2, and 3 also give very high resistances. This result is expected and suggests that the nanoparticles on the surface of the fibers are discrete domains, and little or no charge is transferred between adjacent particles. However, when PEDOT is deposited onto the nanoparticle-coated fibers—thus producing particle interconnects—a significant improvement in yarn electrical conductivity was observed (as shown in Table 1 and FIGS. 14-17) as compared to yarns coated only with nanoparticle, and yarns coated only with PEDOT. FIGS. 14-17 and the following observations serve as a summary of the conductive properties obtained for the yarns produced in the current invention.
There is a linear correlation between measured resistance and the distance between the two probes for PEDOT-nanoparticle-cotton yarns (FIG. 14).
There is a clear improvement in conductive properties when comparing PEDOT-nanoparticle-coated cotton and PEDOT-coated cotton (FIG. 15).
There is a linear dependence of measured current (I) over a range of voltages (V) for (FIG. 16).
The conductive properties of the conductive cotton yarn composites are dependent on the type of nanoparticle deposited onto the fiber surface (FIG. 17).

While the present invention has been described with references to a number of specific embodiments, it will be understood that the true description and scope of the inventions should be determined only with respect to claims that can be supported by the present specification. Moreover, numerous cases herein describe systems, apparatuses and methods as having a certain number of elements, and it will be understood that such systems, apparatuses and methods can be practiced with fewer than the mentioned certain number of elements. While a number of particular embodiments have been described, it will further be understood that features and aspects have been described with reference to each particular embodiment that can be used with each remaining particularly described embodiment.

What is claimed is:

1. An assembly including:
a non-planar fiber with a cross-sectional diameter between 10 nm and 100 μm;
a conformal layer of nanoparticles disposed on the surface of the fiber, the nanoparticles having an average size of between 1 nm and 2000 nm;
interconnects, each one of which is bound to at least two of the nanoparticles;
the assembly having less than about 20 weight percent nanoparticles relative to total weight of the fiber, the nanoparticles and the interconnects.

2. The assembly as recited in claim 1, wherein the fiber is part of a textile substrate selected from the group consisting of a woven textile, a non-woven textile, a woven composite, a knit, a braid or a yarn.

3. The assembly as recited in claim 1, wherein the nanoparticles include a metal or metal oxide.

4. The assembly as recited in claim 2, wherein the nanoparticles include silver, gold, copper, copper oxide, or aluminum-doped zinc oxide.

5. The assembly as recited in claim 1, wherein the nanoparticles comprise a material selected from the group consisting of palladium, platinum, nickel, cobalt, zinc oxide, silicon dioxide, titanium dioxide, iron oxide, aluminum oxide, silver oxide, tin oxide, indium tin oxide, silicon, doped silicon (n or p), germanium, doped germaninum (n or p), cadmium selenide, lead selenide, gallium arsenide, and indium arsenide.

6. The assembly as recited in claim 1, wherein the fiber is a carbohydrate-based fiber or a protein-based fiber.

7. The assembly as recited in claim 1, wherein the fiber is comprised of cotton.

8. The assembly as recited in claim 1, wherein the fiber is comprised of collagen, wool or silk.

9. The assembly as recited in claim 1, wherein the fiber is comprised of a material selected from the group consisting of polyvinyl chlorides, polyvinyl fluorides, polytetrafluoroethylenes, polyvinylidene chlorides, polyacrylics, polyvinyl acetate, polyethylvinyl acetate, non-soluble or soluble polyvinyl alcohols, polyolefins, polyamides, polyesters, polyurethanes, polystyrenes and combinations thereof.

10. The assembly as recited in claim 1, wherein the fiber is comprised of inorganic fibers.

11. The assembly as recited in claim 1, wherein the fiber is comprised of inorganic fibers selected from glass or ceramic.

12. The assembly as recited in claim 1, wherein the interconnects are organic polymers with a molecular weight of at least 200 grams per mole.

13. The assembly as recited in claim 12, wherein the interconnects are electrically conductive polymers, each interconnect comprising a conjugated it system.

14. The assembly as recited in claim 13, wherein the interconnects comprise polymeric material selected from the group consisting of polythiophene, polypyrrole, polyaniline, polyacetylene, polyphenylene vinylene, and polyphenylene sulfide.

15. An assembly including:
a non-planar fiber with a cross-sectional diameter between 10 nm and 100 μm;
a conformal layer of nanoparticles of aluminum-doped zinc oxide disposed on the surface of the fiber, the nanoparticles having an average size of between 1 nm and 2000 nm;
conductive interconnects, each one of which is bound to at least two of the nanoparticles, the interconnects having a conjugated it system;
the assembly having less than about 20 weight percent nanoparticles relative to total weight of the fiber, the nanoparticles and the interconnects.

16. The assembly as recited in claim 15, wherein the fiber is cotton.

17. The assembly as recited in claim 15, wherein the fiber has low electrical resistance such that, when 4 cm of the fiber is subjected to a potential difference of five volts, less than 20 kilohms of resistance results.

18. A method for forming an electrically conductive coated fiber including the steps of:
coating a non-planar fiber having a cross-sectional diameter between 10 nm and 100 μm with a conformal layer of electrically conductive nanoparticles disposed on the surface of the fiber thereby producing a nanoparticle coated fiber, the nanoparticles having an average size of between 1 nm and 2000 nm, such that there is less than about 20 weight percent nanoparticles relative to total weight of the fiber, the nanoparticles and the interconnects;
interconnecting the nanoparticles with electrically conductive interconnects while the nanoparticles are disposed on the fiber, each one of the interconnects being bound to at least two of the nanoparticles, and the interconnects having a conjugated π system.

19. The method as recited in claim 18, further including the step of treating the fiber to provide it with a first charge, prior to the step of coating the non-planar fiber.

20. The method as recited in claim 19, wherein the step of coating the non-planar fiber includes exposing the treated fiber with a first charge to a suspension of the nanoparticles, wherein the nanoparticles have a second charge that is opposite the first charge.

21. The method as recited in claim 18, wherein the coated fiber has a first charge, the step of coating the non-planar fiber further includes exposing the coated fiber with the first charge to a solution of a metal ion having a second charge that is opposite the first charge to produce a resulting composite fiber that is then treated with a reducing agent to provide a metal or metal oxide nanoparticle coating onto the fibers surface, such step being performed prior to the step of interconnecting the nanoparticles.

22. The method as recited in claim 18, wherein the step of interconnecting the nanoparticles includes exposing the nanoparticles to an α,ω functionalized interconnect, wherein the α and ω functional groups are both selected to bind to the surface of the nanoparticles.

23. The method as recited in claim 18, wherein the step of interconnecting the nanoparticles includes exposing the nanoparticle coated fiber to an α,ω functionalized moiety whose α terminus is selected to bind to the surface of the nanoparticles and whose ω terminus is selected to polymerize when exposed to a monomer under polymerization conditions, thus binding the α,ω functionalized moiety to at least two of the nanoparticles at its a terminus.

24. The method as recited in claim 18, wherein the step of interconnecting the nanoparticles includes exposing the nanoparticle coated fiber to a localized polymerization catalyst to form a resulting fiber composite, exposing the resulting fiber composite to a monomer under polymerization conditions such that the monomer polymerizes by interacting with the localized catalyst and continues to polymerize until monomer is exhausted, and the resulting polymer is then localized to the nanoparticles, thus interconnecting the nanoparticles.

25. The method of claim 24, wherein the polymerization catalyst includes iron (III) chloride or iron (III) tosylate.

26. The method of claim 24, wherein the monomer includes at least one compound selected from the group thiophene, pyrrole, aniline, acetylene, phenylene vinylene, and phenylene sulfide.
